(19) United States
(12) Patent Application Publication
(10) Pub. No.: US 2021/0201282 A1
(43) Pub. Date: Jul. 1, 2021

(54) COMMUNITY DEFINED SPACES

(71) Applicant: PANASONIC INTELLECTUAL PROPERTY MANAGEMENT CO., LTD., Osaka (JP)

(72) Inventors: Jan Jasper van den BERG, London (GB); David Michael DUFFY, Zurich (CH); Matthew John LAWRENSON, Chesterfield, MO (US)

(73) Assignee: PANASONIC INTELLECTUAL PROPERTY MANAGEMENT CO., LTD., Osaka (JP)

(21) Appl. No.: 17/201,409

(22) Filed: Mar. 15, 2021

Related U.S. Application Data
(63) Continuation of application No. PCT/JP2019/037393, filed on Sep. 24, 2019.
(60) Provisional application No. 62/735,254, filed on Sep. 24, 2018.

(51) Int. Cl. G06Q 20/20; G06Q 50/26

(52) U.S. Cl. CPC G06Q 20/20; G06Q 50/26

(57) ABSTRACT

Various systems, methods, and media for providing control and usage over public spaces are provided. Digital currency is issued to each of a plurality of users. Public activities that may be carried out by the users at the public spaces are identified. A request from a user to carry out a public activity is received. A value is assigned to the public activity, based at least on the public activity. A transaction with the user is processed, with the transaction authorizing the user to carry out the public activity. An amount of the digital currency of the user is acquired in response to the transaction being completed, with the amount corresponding to the value of the public activity. Rights are assigned to the user to carry out the public activity in response to the transaction being completed.

### CROSS-REFERENCE TO RELATED APPLICATIONS

This application is a continuation of PCT International Patent Application No. PCT/JP2019/037393 filed on Sep. 24, 2019, which claims the benefit of priority of U.S. Provisional Patent Application No. 62/735,254 filed on Sep. 24, 2018, the entire contents of which are incorporated herein by reference.

### FIELD

The present disclosure generally relates to technical areas including street, flex-zoning, public spaces, and community engagement. Specifically, the present disclosure relates to various embodiments for providing control and usage over public spaces.

### BACKGROUND

The rise in e-commerce deliveries, bike lanes, and ride-sharing services is changing street design requirements, resulting in the need to remove parking in some areas, or to transform parking into pull-over spots or flex-zones. Further, the adoption of Autonomous Vehicles (AVs) may result in an even larger transformation of how streets and public spaces are arranged and used by people and vehicles, for example, due to the introduction of mobile shops.

Future streets are predicted to implement technological developments to create spaces whose design and infrastructure are not static, but adaptive to changing conditions in the city.

Such technological developments and smart city technologies are projected to save citizens as much as 125 hours a year, through developments including improved transportation. Some early technologies are already in use or development today, such as variable traffic controls on highways and other active traffic management systems. Such technological developments and smart functions may also be able to assist communities with various uses of public spaces. For example, food trucks have become a popular and common feature of many public spaces, but sellers may find it difficult to obtain permits and find spaces to operate legally in a timely manner.

### SUMMARY

The present disclosure, through one or more of its various aspects, embodiments, and/or specific features or sub-components, provides, inter alia, various systems, servers, devices, methods, media, programs, and platforms for providing control and usage over public spaces. The various aspects, embodiments, features, and/or sub-components provide for developments and communities that include public spaces which are adaptive to changes in conditions. The various aspects, embodiments, features, and/or sub-components allow for users to equally and easily perform activities or use such public spaces consistent with social and societal norms. Accordingly, by the present disclosure, optimized processes for intelligently and dynamically managing public space utilization are provided, in line with both the needs of those users who wish to use it and any municipal requirements.

In particular, the various aspects, embodiments, and/or specific features or sub-components assign values to on-street activities or other uses of public spaces, as well as to the required areas for these activities and uses. Users trade or purchase the rights to a particular activity or use through a user interface, and a system assigns the rights by issuing digital notifications and/or physical infrastructure changes, allowing the users to carry out the desired activities or uses.

According to an embodiment of the present disclosure, a system for providing control and usage over public spaces is provided. The system includes: a processor; and a memory including instructions that, when executed by the processor, cause the processor to perform operations. The operations include the processor: issuing digital currency to each of a plurality of users; identifying public activities or uses that may be carried out by the plurality of users at the public spaces; receiving a request from a user to carry out a public activity or use, with the user being one of the plurality of users and the public activity or use being one of the public activities or uses; assigning a value to the public activity or use, based at least on the public activity or use; processing a transaction with the user, with the transaction authorizing the user to carry out the public activity or use; and assigning rights to the user to carry out the public activity or use in response to the transaction being completed. In this regard, an amount of the digital currency of the user is acquired in response to the transaction being completed. The amount of the digital currency corresponds to the value of the public activity or use.

According to an aspect of the present disclosure, the operations further include the processor subjecting the rights of the user to carry out the public activity or use, in response to the transaction being completed, to at least one condition.

According to another aspect of the present disclosure, the at least one condition, to which the rights of the user to carry out the public activity or use are subject, includes a specific location at which the public activity or use is to be carried out.

According to yet another aspect of the present disclosure, in assigning rights to the user to carry out the public activity or use at the specific location, the processor limits assignments of rights for similar activities or uses that are to be carried out within a predetermined distance of the specific location to a predetermined number.

According to a further aspect of the present disclosure, in assigning the value to the public activity or use, the processor further assigns the value based on the specific location at which the public activity or use is to be carried out.

According to still a further another aspect of the present disclosure, in assigning the value to the public activity or use, the processor further assigns the value based on real-time use statistics of the public spaces.

According to another aspect of the present disclosure, the real-time use statistics of the public spaces includes real-time traffic conditions, with the real-time traffic conditions being determined from vehicle sensors and autonomous vehicle reports.

According to yet another aspect of the present disclosure, the request from the user to carry out the public activity or use includes a requested location, and the specific location at which the public activity or use is to be carried out is determined by the processor to be within a predetermined distance of the requested location.

According to a further aspect of the present disclosure, the request from the user to carry out the public activity or use includes the specific location.

According to still a further another aspect of the present disclosure, the operations further include the processor identifying available locations of the public spaces at which the public activities or uses may be carried out by the plurality of users, with the processor comparing current public space usage and current conditions with upcoming public space usage and predicted conditions.

According to another aspect of the present disclosure, the at least one condition, to which the rights of the user to carry out the public activity or use are subject, further includes a specific time period during which the public activity or use is to be carried out.

According to yet another aspect of the present disclosure, the request from the user to carry out the public activity or use is at least one of received from a user device or identifies a user device, and the operations further include the processor transmitting a start instruction to the user device to permit usage of the specific location for carrying out the public activity or use by the user a predetermined amount of time before a start of the specific time period.

According to a further aspect of the present disclosure, the operations further include the processor transmitting an end instruction to the user device to end usage of the specific location for carrying out the public activity or use by the user a predetermined amount of time before an end of the specific time period.

According to still a further another aspect of the present disclosure, the operations further include the processor processing a penalty transaction with the user in response to the user not ending usage of the specific location by the end of the specific time period. A penalty amount of the digital currency of the user is acquired in response to the penalty transaction being completed. The penalty amount of the digital currency corresponds to a predetermined amount of the value of the public activity or use.

According to another aspect of the present disclosure, the operations further include the processor transmitting a control instruction to the user device for controlling the user device to exit the specific location a predetermined amount of time before or after an end of the specific time period.

According to yet another aspect of the present disclosure, the memory stores a layout of the public spaces. The operations further include the processor dynamically altering the layout of the public spaces based on the rights assigned to the user to carry out the public activity or use, and causing a physical infrastructure change to be instituted in response to the layout of the public spaces being dynamically altered.

According to a further aspect of the present disclosure, the system includes a platform for exchanging the digital currency of the plurality of users for rights to carry out the public activities or uses. The platform is further for trading the digital currency amongst the plurality of users, and for exchanging the rights to carry out the public activities or uses.

According to still a further another aspect of the present disclosure, the operations further include the processor: issuing unique identifiers to each of a plurality of users, with the digital currency being issued to each of the plurality of users in accordance with the unique identifiers; and recording the transaction and the rights assigned to the user, to carry out the public activity or use in response to the transaction being completed, in a digital ledger in association with a unique identifier of the user.

According to another embodiment of the present disclosure, a method for providing control and usage over public spaces is provided. The method includes: issuing digital currency to each of a plurality of users; identifying public activities or uses that may be carried out by the plurality of users at the public spaces; receiving a request from a user to carry out a public activity or use, with the user being one of the plurality of users and the public activity or use being one of the public activities or uses; assigning, by a processor, a value to the public activity or use based at least on the public activity or use; processing, by the processor, a transaction with the user, with the transaction authorizing the user to carry out the public activity or use, an amount of the digital currency of the user being acquired in response to the transaction being completed, and the amount of the digital currency corresponding to the value of the public activity or use; and assigning, by the processor, rights to the user to carry out the public activity or use in response to the transaction being completed.

According to yet another embodiment of the present disclosure, a non-transitory computer-readable medium including a set of instructions for providing control and usage over public spaces is provided. The set of instructions, when executed by a computer, causes the computer to perform operations including: issuing digital currency to each of a plurality of users; identifying public activities or uses that may be carried out by the plurality of users at the public spaces; receiving a request from a user to carry out a public activity or use, with the user being one of the plurality of users and the public activity or use being one of the public activities or uses; assigning a value to the public activity or use, based at least on the public activity or use; processing a transaction with the user, with the transaction authorizing the user to carry out the public activity or use, an amount of the digital currency of the user being acquired in response to the transaction being completed, and the amount of the digital currency corresponding to the value of the public activity or use; and assigning rights to the user to carry out the public activity or use in response to the transaction being completed.

### BRIEF DESCRIPTION OF DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system for providing control and usage over public spaces, according to an aspect of the present disclosure.

FIG. 2A illustrates a first exemplary embodiment of a system for providing control and usage over public spaces, according to an aspect of the present disclosure.

FIG. 2B illustrates a second exemplary embodiment of a system for providing control and usage over public spaces, according to an aspect of the present disclosure.

FIG. 2C illustrates a third exemplary embodiment of a system for providing control and usage over public spaces, according to an aspect of the present disclosure.

FIG. 3 illustrates a method for providing control and usage over public spaces, according to aspects of the present disclosure.

FIG. 4 illustrates a method for providing control and usage over public spaces, according to aspects of the present disclosure.

### DETAILED DESCRIPTION

In view of the foregoing, the present disclosure, through one or more of its various aspects, embodiments and/or specific features or sub-components, is thus intended to bring out one or more of the advantages as specifically noted below.

For example, the present disclosure issues digital currency to users within a development or community, such that the users may request and transact to carry out activities or otherwise use public spaces for dynamically calculated rates. In this regard, early smart city developments have shown that top-down planning can alienate citizens, with the focus being on implementing new technologies rather than building communities. The embodiments and/or specific features or sub-components described herein, thus, help city planning and/or planners to implement urban design to better meet the needs of communities without top-down planning. The users, such as residents, retailers, and/or vehicle owners, are given increased control over the layout and usage of public spaces.

In addition, new developments and communities, urban, local, and otherwise, are increasingly taking into account social and community factors, and not simply the capacity of a development for economic profit. It is increasingly recognized that such developments and communities must consider the quality of life of the people who will inhabit them. Engaging such developments and communities will make smart cities more responsive to the needs of the people and improve the quality of life. Giving developments and communities increased power and responsibility over the public space creates more efficient and dynamic street designs and reconnects developments and communities to their neighbors and their built environment. The embodiments and/or specific features or sub-components described herein thus determine the relative value of an activity or use of space compared to others, taking into account the changing needs and conditions of the developments and communities, and spaces thereof.

Even further, the problem of “pseudo-public” spaces has recently emerged, whereby spaces thought to be public-owned for public use have been revealed to be privately-owned, meaning that the scope for public use of these spaces is controlled by a private entity. The embodiments and/or specific features or sub-components described herein provide transparency as to the nature and availability of public spaces, as well as “pseudo-public” spaces.

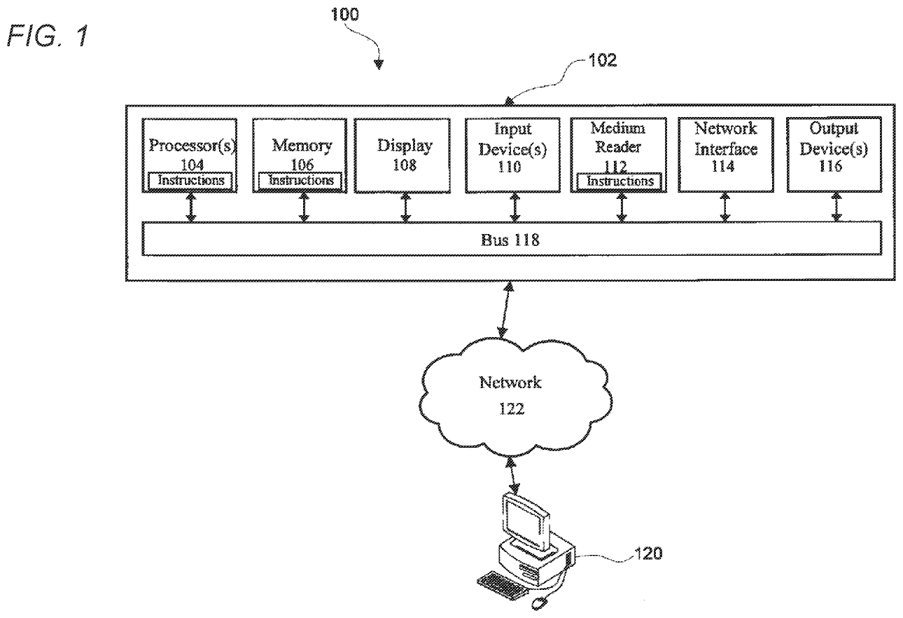

FIG. 1 is an exemplary computer system for use in accordance with the embodiments described herein. The system 100 is generally shown and may include a computer system 102, which is generally indicated. The system 100 may be used to, for example, issue digital currency to users within a development or community, such that the users may request and transact to carry out activities or otherwise use public spaces for dynamically calculated rates.

The computer system 102 may include a set of instructions that can be executed to cause the computer system 102 to perform any one or more of the methods or computer based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a video display 108, such as a liquid crystal display (LCD), an organic light emitting diode (OLED), a flat panel display, a solid state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read anyone or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present disclosure, the computer device 120 may be a laptop computer, a tablet PC, a personal digital assistant, a mobile device, a palmtop computer, a desktop computer, a communications device, a wireless telephone, a personal trusted device, a web appliance, a server, an autonomous vehicle, a drone, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present disclosure. For example, the computer device 120 may be the same or similar to the computer system 102. Furthermore, those skilled in the art similarly understand that the computer device 120 may be any combination of devices and apparatuses. For example, as described above, the computer device 120 may be, or be included within, an autonomous vehicle or a drone.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

As described herein, various embodiments provide optimized processes for intelligently and dynamically managing public space utilization, in line with both the needs of those users who wish to use it and any municipal requirements. The various embodiments, among other features, issue digital currency to users within a development, community, or other municipality, such that the users may request and transact to carry out activities or otherwise use public spaces for dynamically calculated rates.

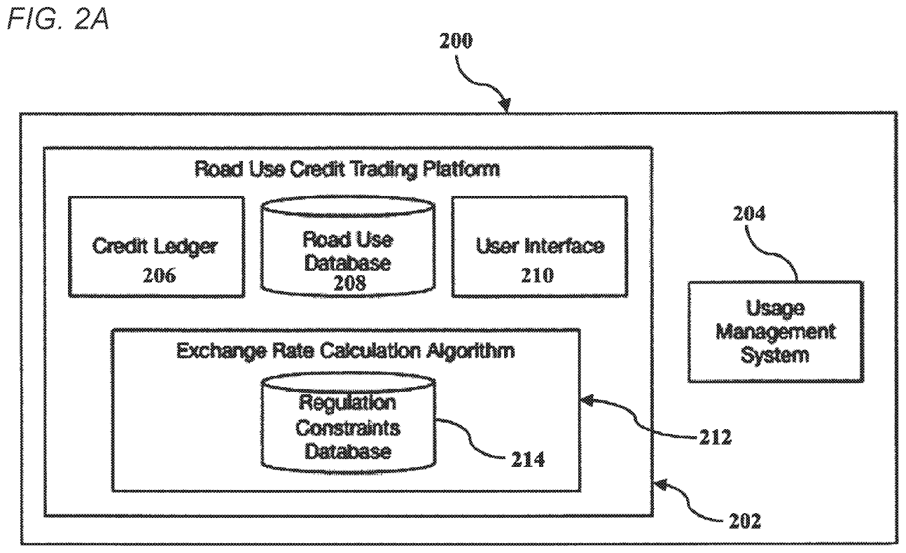

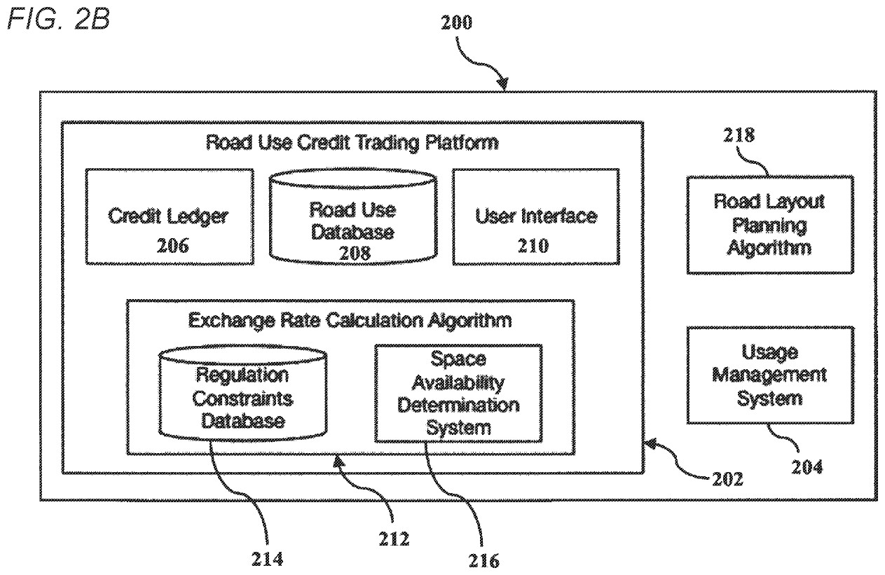

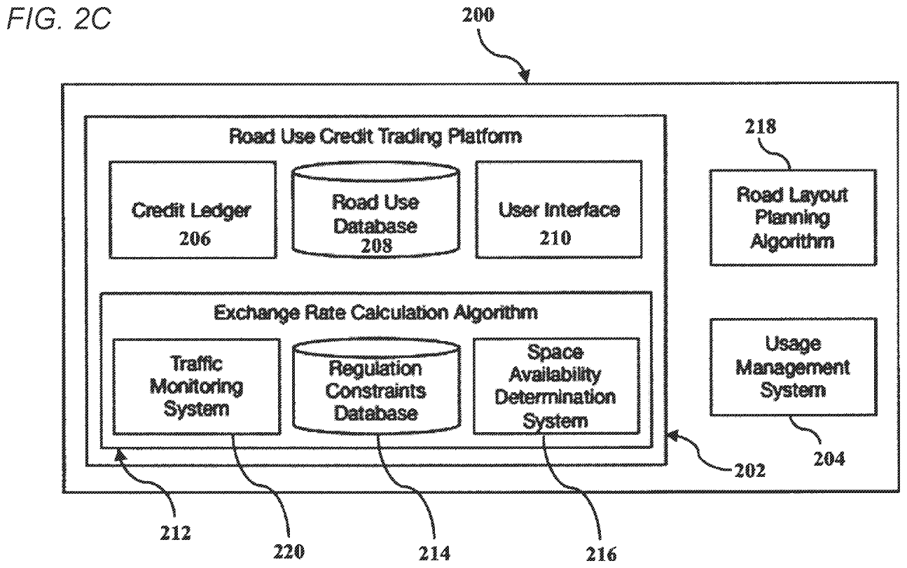

Referring to FIG. 2A, a schematic of a first exemplary system 200 for providing control and usage over public spaces is illustrated.

The system 200 may be owned by, operated by, controlled by, or otherwise associated with any local, national, regional, state, federal, or other government or government-sponsored development, community, municipality, or agency. For example, in embodiments of the present disclosure, the system 200 may be operated by or associated with a local authority, such as a city council or administrative government body responsible for town planning, traffic management, and/or other regulations relevant to the use of public spaces. The system 200 is described hereinafter as being used by a Municipal Authority to manage public spaces within its jurisdiction for convenience. The Municipal Authority may be, for example, a transit or airport authority. Of course, the Municipal Authority may additionally or alternatively be any of the entities described above or otherwise herein, or any equivalent or similar entity, without departing from the scope of the present disclosure. For example, rules or regulations concerning planning or space management may be agreed upon between individuals, such as by contract between residents, business owners or a neighborhood committee. In other words, the Municipal Authority may additionally or alternatively comprise a home owners association, or same or similar public or private association. In any event, it is to be known and understood that the Municipal Authority may additionally or alternatively be any of the entities described herein or otherwise known and understood in the art.

The public spaces which are managed or otherwise controlled by the Municipal Authority may include any type of public space such as roads, parks, buildings, squares, beaches, etc. Of course, these examples are merely exemplary and are not limiting or exhaustive. Additional or alternative types of public spaces, or combinations thereof, may be included without departing from the scope of the present disclosure. Further, while the public spaces are described as being “public”, it is to be known and understood that the public spaces may additionally or alternatively include pseudo-public or even private spaces. The skilled artisan would readily understand that such spaces may be included within the present disclosure without departing from the various features and aspects described herein.

The system 200 is generally shown in FIG. 2A as including a Road Use Credit Trading Platform 202 and a Usage Management System 204. The Road Use Credit Trading Platform 202 is generally indicated and includes a Credit Ledger 206 a Road Use Database 208, a User Interface 210, and an Exchange Rate Calculation Algorithm 212. In this regard, while the Road Use Credit Trading Platform 202 is shown as including the various components 206-212, it is to be known and understood that the Road Use Credit Trading Platform 202 may be the same or equivalent to the computer system 102 of FIG. 1. That is, the various components 206-212 of the Road Use Credit Trading Platform 202 may be implemented by the above-described components of the computer system 102. For example, the functions of the various components 206-212 may be implemented, in total or in part, by the processor 110 executing instructions stored in the memory 106 and/or the medium reader 112 of FIG. 1. The same applies to the Usage Management System 204. That is, the Usage Management System 204 may additionally or alternatively be implemented, in total or in part, by the processor 110 executing instructions stored in the memory 106 and/or the medium reader 112 of FIG. 1.

In any event, the Road Use Credit Trading Platform 202 is a platform through which Road Users may exchange digital currency to acquire the right to carry out particular activities or uses of public spaces under specified conditions.

While the phrase “Road” User is used herein, it is to be understood that the user need not necessarily use a “road”, per se. The Road User may by any pedestrian, individual, resident, or entity of a development and/or community that uses any of the public spaces defined herein. Further, the Road User need not necessarily be an individual or person. The Road User may be any entity that uses any of the public spaces defined herein such as, but not limited to, a vehicle, an individual, or an organization. The vehicle may be, for example, a car, an autonomous taxi or other vehicle, a delivery robot, and/or a drone. The individual may be, for example, a person, a resident, a performer, and/or a small business owner. The organization may be, for example, a company, a group, and/or other collective. Of course, the above-described examples are merely exemplary and are not limiting or exhaustive. The individual may be any further entity or combination of entities without departing from the scope of the present disclosure. In any event, the phrases Road User and Road Users are principally used herein for convenience and clarity. Nevertheless, it is to be known and understood that these phrases may refer to user(s) and/or any of the above-described devices which are operated or controlled by user(s).

The system 200, Municipal Authority, and/or Road Use Credit Trading Platform 202 may issue or distribute the digital currency to each of a plurality of Road Users. The digital currency may be any type of electronic or digital currency which is generally known and understood in the art. In this regard, the digital currency need not necessarily be actual digital or electronic money. That is, the digital currency may comprise credits which are issued by the system 200, Municipal Authority, and/or Road Use Credit Trading Platform 202 and which have little use or value outside of the Road Use Credit Trading Platform 202. As a result, the digital currency may be referred to hereinafter as Road Use Credits for convenience. Nevertheless, it is to be known and understood that the phrases “digital currency” and “Road Use Credits” are not to be limiting. Additional monies, points, vouchers, etc., digital/electronic or otherwise, may be used herein without departing from the scope of the present disclosure.

The amount of Road Use Credits issued to the Road Users may vary by Road User and/or with the goals of the Municipal Authority. That is, the Road Use Credits may be issued equally or based on any other criteria which is known and understood in the art. For example, the Road Use Credits may be issued increasingly or decreasingly based on social or economic status, duration in the community, past use of Road Use Credits, expected future use of Road Use Credits, employer or employment status, etc. Nevertheless, it is to be known and understood that these examples are merely exemplary and are not limiting or exhaustive. Such manner in which the Road Use Credits are issued does not affect the scope of the various embodiments of the present disclosure.

Also, the Road Use Credits may be issued to all Road Users which are a part of a development and/or community. In other words, the system 200 may issue the digital currency to the plurality of Road Users based on their mere association with the development and/or community. Alternatively, the Road Use Credits may be issued to the Road Users, either equally or unequally, based on characteristics or standings within a development and/or community. For example, the Road Use Credits may be issued to certain Road Users based on proximity to the public spaces, geographic locations of the Road Users, physical or mental characteristics of the Road Users, religious or other affiliations of the Road Users, etc. In any event, in embodiments of the present disclosure, the Road Use Credits are merely issued amongst a plurality of Road Users, such that the Road Users may purchase the rights to use public spaces for specified purposes, as will be described herein.

In certain embodiments, however, the Road Users may be required to register with the Municipal Authority and/or the Road Use Credit Trading Platform 202 to receive the Road Use Credits. In such embodiments, each of the Road Users may be assigned or associated with a unique identifier which may be used to track the transactions made by the Road User, the digital currency issued to the Road User, and/or data associated with the Road User. The unique identifier may be anonymous or specifically associated with the identity of the Road User. The unique identifier may be alphabetic, numeric, alphanumeric, and/or comprise biometric data. The unique identifier is described hereinafter as a Road User ID. Nevertheless, it is to be known and understood that the unique identifier may be any identifier capable of being associated with the Road User.

The Credit Ledger 206 may be a ledger in which the Road Users and Road Use Credits issued thereto are recorded. The Credit Ledger 206 may further comprise a ledger or system through which all Road Use Credit transactions of all Road Users may be recorded. The Road Use Credit transactions may occur between: (i) a Road User and the Municipal Authority and/or the Road Use Credit Trading Platform 202, e.g., during the initial distribution of Road Use Credits and/or the subsequent purchase or Road Usage Rights (which will be described hereinafter); and (ii) a Road User and other Road Users, e.g., through trades in which a Road User acquires extra Road Use Credits from another by purchase or acquires Road Usage Rights from another by purchase. The Road Use Credits and/or Road Usage Rights may be exchanged amongst Road Users by purchase via any Fiat currency, commodity, or any other negotiated goods and service.

The Credit Ledger 206 may be realized through, for example, a blockchain ledger. That is, the blockchain may used to record and store all, or a specific type, of Road Use Credit transactions.

Blockchain technology can provide a record of how an asset is passed through a system, which may be applied to track transfer and use of the Road Use Credits. In a blockchain system, the ownership of an asset can be traced from its creation to a current owner. The ability to track a chain of ownership allows for broad application of the blockchain technology as it allows a transferor Road User to track his or her Road Use Credits to their final use. Accordingly, the blockchain technology may provide the transferor Road User with a level of assurance by allowing the transferor Road User to verify that his or her Road Use Credits have been used for an acceptable purpose. Further, the blockchain technology allows a recipient Road User to track the purchased and/or traded-for Road Use Credits to their initial distribution, in order to provide a level of assurance as to the authenticity of the Road Use Credits. Although the blockchain technology has been primarily utilized for purposes of tracking new digital currencies, such as bitcoin, aspects of the present disclosure are not limited thereto. In the instant disclosure, the blockchain may be utilized to implement a credit transfer system which is not based on traditional digital currencies, and instead tracks the Road Use Credits.

While the Credit Ledger 206 is described above as being realized through a blockchain ledger, it should be known and understood that the present disclosure is not limited thereto. That is, the Credit Ledger 206 may comprise any distributed database that stores a set of records organized into blocks. Each block may be time-stamped and linked to a previous block or blocks via a method that is resistant to the modification of previous blocks. In this regard, the Credit Ledger 206 may comprise any decentralized, peer-to-peer networked database that is configured to store and authenticate a ledger of transactions relating to the Road Use Credits. Each transaction completed by the Road Users may be tagged with the involved Road Use Credits, the Road User ID(s), a Road Use identifier (which will be described hereinafter), and/or any related Road Usage Rights. Accordingly, the Credit Ledger 206 may facilitate transactions without a third-party intermediary, and may instead be validated by consensus. As new blocks are added the difficulty to modify previous blocks increases, with the aim that, after several new blocks have been added, it will become unjustifiable to do so, even for malicious purposes. Hence, if designed well, even though no central authority manages the Credit Ledger 206, the validity of the data therein may be trusted by all Road Uses, as it becomes impractical to modify it for malicious purposes.

Accordingly, when the system 200, Municipal Authority, and/or Road Use Credit Trading Platform 202 issues or distributes the digital currency to each of the Road Users, the distributions are recorded in the Credit Ledger 206. Thereafter, when the Road Users transact with the system 200, the Municipal Authority, the Road Use Credit Trading Platform 202, and/or one another to use or trade the Road Use Credits, such transactions are further recorded in the Credit Ledger 206 with reference to previous transactions including the initial distribution.

Thus, the Credit Ledger 206 tracks the issuance and use of the Road Use Credits by the Road Users. While the Credit Ledger 206 is generally described above as including a ledger, blockchain or otherwise, it is to be known and understood that additional or alternative means for tracking the issuance and use of the Road Use Credits by the Road Users may be employed. For example, the Credit Ledger 206 may be operated through a database system as generally known and understood in the art. In any event, the Credit Ledger 206 may be implemented via any known and understood method without departing from the scope of the present disclosure.

Accordingly, as generally described above, the Road Users are issued the Road Use Credits such that they may acquire rights to carry out activities in public spaces and/or to use such public spaces. In this regard, information about the various permitted activities and uses is stored in the Road Use Database 208. The various permitted activities and uses are described hereinafter as Road Uses for convenience. Nevertheless, it is to again be understood that the term “Road” is used herein for clarity but is not meant to be limiting. That is, the various permitted activities and uses need not necessarily be performed on or use a “road,” per se.

The information about the Road Uses (e.g., the various permitted activities and uses) may include: (i) a type of Road Use; and (ii) a space required for the Road Use to be carried out. In this regard, the type of Road Use may include, for example: activities, such as a musical or artistic street performance; operation of temporary stalls or outlets, such as a street food stand or souvenir shop; parking a vehicle, perhaps for a specified time period; loading/unloading a vehicle, for example, for package delivery or passenger drop off; and placing outdoor furnishings, such as cafe tables or signage. The space required for the Road Use to be carried out may include: a square footage; a number of public spaces, for example, when the public spaces are divided into parcels; a specific type of public space, for example, when different types of public spaces are provided such as compact and oversized; a specific type of surface, such as grass, gravel, pavement, etc.; a certain characteristic, such as an electrical outlet; and a certain location, such as adjacent a park or sidewalk. Of course, the above-described examples are merely exemplary and are not limiting or exhaustive. The Road Use Database 208 may store any additional or alternative Road Uses, or characteristics thereof, without departing from the scope of the present disclosure. Further, while it is generally described herein that the Road Use Database 208 stores the permitted Road Uses, it should be known and understood that additional Road-User-Specified Road Uses may be permitted in additional embodiments of the present disclosure.

Accordingly, the Credit Ledger 206 generally stores the Road Use Credits of the Road Users, and the Road Use Database 208 stores the permitted Road Uses. In this regard, a Road User may utilize the User Interface 210 to request rights to carry out one of the permitted Road Uses using his or her Road Use Credits. The User Interface 210 is an interface through which the Road Users may access the Road Use Credit Trading Platform 202. The User Interface 210 may be a digital interface such as a mobile application, web-based application, other application, or website, but may additionally or alternatively take other forms as generally known and understood in the art. The User Interface 210 may be used to, for example: (i) purchase Road Usage Rights from the system 200, the Municipal Authority, and/or the Road Use Credit Trading Platform 202; (ii) purchase or trade Road Use Credits from other Road Users; and (iii) indicate a Road User's current Road Usage Rights, including specific information pertaining to the location, time or other associated conditions of assigned rights for a permitted Road Use. Of course, these functions are merely exemplary and the User Interface 210 may have additional and/or alternative functions without departing from the scope of the present disclosure.

Upon a Road User using the User Interface 210 of the Road Use Credit Trading Platform 202 to acquire rights to carry out one of the Road Uses in a public space, the Exchange Rate Calculation Algorithm 212 calculates a value of the one Road Use, which is used to determine the amount of Road Use Credits which the Road User must use to purchase rights for carrying out the one Road Use. Such rights for carrying out a Road Use are hereinafter referred to as Road Usage Rights for convenience. Furthermore, the amount for purchasing such Road Usage Rights is hereinafter referred to as an Exchange Rate.

The Exchange Rates for purchasing the Road Usage Rights may be determined independently or relative to one another. In this regard, the system 200, Municipal Authority, and/or Road Use Credit Trading Platform 202 may encourage certain Road Uses over other Road Uses. Furthermore, the system 200, Municipal Authority, and/or Road Use Credit Trading Platform 202 may attempt to increase or decrease demand in accordance with the needs or wants of the community or development. In such embodiments, the Exchange Values may be arbitrarily set relative to one another based on demand and/or other criteria. Alternatively, the Exchange Values may be calculated or arrived at via a predetermined formula or algorithm.

For example, in calculating the amount required for purchasing the Road Usage Rights, the Exchange Rate Calculation Algorithm 212 may take into account various parameters, hereinafter referred to as “Valuation Parameters”, which may cause the Exchange Rates to fluctuate. The Valuation Parameters may relate to, for example, local regulations and planning requirements as defined by the system 200, Municipal Authority, and/or Road Use Credit Trading Platform 202. Such local regulations and/or planning requirements may relate to, for example: traffic flow of vehicles; overcrowding; safe movement of vehicles, including municipal and emergency vehicles; hygiene and food safety standards; and other predetermined usage requirements related to specific Road Uses. In this regard, as shown in FIG. 2A, the Road Use Credit Trading Platform 202 may include a Regulation Constraints Database 214 which includes information about the local regulations and/or planning requirements. The local regulations and/or planning requirements described above are merely exemplary, and the Regulation Constraints Database 214 may include further regulations and/or requirements which are generally known and understood upon which the Exchange Rate Calculation Algorithm 212 may calculate the Exchange Rates without departing from the scope of the present disclosure.

In further embodiments of the present disclosure, the Valuation Parameters may additionally or alternatively relate to the availability of the public spaces within which Road Uses may take place. Such availability of the public spaces may relate to, for example: existing Road Usage Rights previously purchased by Road Users; physical space availability; and predicted or upcoming increases in pedestrian or vehicle numbers due to scheduled or predicted events. In this regard, as shown in FIG. 2B, the Road Use Credit Trading Platform 202 may further include a Space Availability Determination System 216 which determines information about the availability of the public spaces. The Space Availability Determination System 216 may include or be connected to city plans, security cameras, vehicle sensors, drone sensors, or other means such that the physical space availability may be obtained. Accordingly, in these embodiments, the quantity, quality, and/or availability of the public spaces may be considered by the Exchange Rate Calculation Algorithm 212. That is, the Space Availability Determination System 216 may compare current physical space constraints with predicted requirements to determine whether a Road Use request can be easily facilitated. The ease or difficulty in facilitating the Road Use request may be reflected in the Exchange Rate of such Road Use.

Accordingly, in the above-described embodiments and as generally shown in FIG. 2A and FIG. 2B, the Exchange Rates may be determined in accordance with or based on the Road Uses and/or the public spaces. That is, the Exchange Rate Calculation Algorithm 212 may account for either or both of the types of Road Uses and/or the public spaces required for the Road Uses to be carried out in determining the Exchange Rates for the Road Usage Rights.

Further, in additional embodiments of the present disclosure, the Exchange Rate Calculation Algorithm 212 may consider additional parameters in determining the Exchange Rates for the Road Usage Rights. For example, real-time traffic conditions may be considered, as they may affect existing and future Road Uses. In this regard, as shown in FIG. 2C, the Road Use Credit Trading Platform 202 may include a Traffic Monitoring System 220 that may track traffic conditions. The traffic conditions may be tracked through devices or means including, but not limited to, vehicle sensors, autonomous vehicle reporting mechanisms, and/or smart city sensing platforms The traffic conditions may be monitored or tracked to identify conditions which may limit the availability of Road Uses. When the availability of certain Road Uses is low, the Exchange Rates for such Road Uses may be increased to maintain an appropriate supply-and-demand relationship. Further, existing and/or future Road Usage Rights may be manipulated by the associated Exchange Rates to alleviate traffic flow issues. That is, the Exchange Rates may be increased during current or predicted times having traffic flow issues to limit or discourage Road Uses during such times to alleviate the traffic flow issues.

Thus, the Exchange Rate Calculation Algorithm 212 may determine the Exchange Rates for the Road Usage Rights based on any combination of the above-mentioned parameters, as set forth with respect to the Regulation Constraints Database 214, the Space Availability Determination System 216, and/or the Traffic Monitoring System 220. In this regard, the Regulation Constraints Database 214, the Space Availability Determination System 216, and/or the Traffic Monitoring System 220 may determine the parameters in accordance with real-time conditions, or based on predicted conditions. The predicated conditions may be determined in accordance with past events. For example, the Systems 214, 216, 220 may presume that like days, times, and/or events in the past will result in similar current conditions. Additionally or alternatively, the predicated conditions may be determined in accordance with future events. That is, when certain events are known to be occurring in the future, the Systems 214, 216, 220 may account for such events in determining the parameters.

Further, in an additional or alternative exemplary embodiment of the present application, the Exchange Rates for purchasing the Road Usage Rights of the various Road Uses may be compared relative to one another. That is, an average, median, or Road Use otherwise determined to have a neutral value or impact on the development or community may be determined to have an Exchange Rate of a predetermined value. Road Uses which are determined to be more impactful for a Road User and/or less beneficial for the development or community may be assigned an Exchange Rate greater than the predetermined value, while Road Uses which are determined to be less impactful for a Road User and/or more beneficial for the development or community may be assigned an Exchange Rate less than the predetermined value. According to such relative assignment of Exchange Rates, the system 200. Municipal Authority, and/or Road Use Credit Trading Platform 202 may encourage Road Uses which are more beneficial to the development or community. In this regard, the system 200, Municipal Authority, and/or Road Use Credit Trading Platform 202 may also attempt to skew the ratio of Road Uses which benefit the development or community to being more favorable.

In an embodiment further to the one described in the immediately preceding paragraph, the predetermined value may even be set to a value such as zero. According to such embodiment, certain Road Uses which may be deemed more beneficial to the development or community may have a negative Exchange Rate, whereby a Road User may accumulate Road Use Credits by acquiring the associated Road Usage Rights. The Road User may further be required to satisfactorily perform the Road Use before acquiring such Road Use Credits. Nevertheless, a Road User may be incentivized to perform Road Uses which are deemed beneficial to the development or community such that he or she may acquire more Road Use Credits, whereupon the Road User may acquire Road Usage Rights for Road Uses which are more impactful or beneficial to the Road User (and possibly less beneficial to the development or community). Of course these embodiments are merely exemplary and the Exchange Rates may be assigned in any additional or alternative manners.

In any event, the Exchange Rate Calculation Algorithm 212 determines the Exchange Rates for the Road Usage Rights. Such Road Usage Rights, when exchanged for the Road Use Credits, allow the Road Users to carry out the Road Uses.

The Road Usage Rights, even when assigned, may be subject to one or more conditions or parameters. The conditions or parameters may be applied by the system 200, Municipal Authority, and/or Road Use Credit Trading Platform 202. The conditions or parameters may be applied in response to the Valuation Parameters or any of the other factors described above.

For example, the Road Usage Rights may permit a Road Use to be carried out only at a specific location or public space. In this regard, the specific location or public space may be selected or approved by a Road User before transacting for the Road Usage Rights. Alternatively, the Road User may select or approve an area or region in which the specific location or public space is located prior to transacting for the Road Usage Rights. The specific location or public space may be identified by grid coordinates or any other method known and generally understood in the art. The specific location or public space may be identified as a single point, or the specific location or public space may be identified as a plot or area. In this regard, the plot or area may be wholly contained within the specific location or public space, such that a buffer area is provided around the specific location or public space. Accordingly, in the event the Road User is an autonomous vehicle, a risk of the Road user approaching or encroaching a boundary of the specific location or public space is minimized.

The coordinates, or other identifier, of the specific location or public space may be transmitted to the Road User, or a user device identified or operated by the Road User, upon assignment of the Road Usage Rights. The user device may be identified by the Road User via the User Interface 210 during assignment of the Road Usage Rights, or determined in accordance with any other known methods in the art. The user device may be the same or similar to the one or more additional computer devices 120 of FIG. 1, for example. Further, as generally described above, the Road User may be the same or similar to the user device, such as when the Road User is an autonomous vehicle. In this regard, in the following paragraphs, transmissions will be described as being with respect solely to the Road User. Nevertheless, it is to be known and understood that such transmissions may equally be to a user device associated with the Road User.

Accordingly, as one condition or parameter, the Road Usage Rights may be limited to a single public space, or area of public spaces, in which the associated Road Use must be carried out.

As an additional condition or parameter, the Road Usage Rights may be prescribed for a certain time limit or time period. That is, the Road Use associated with the Road Usage Rights may be required to be performed during a specific time period, or within a certain timeframe. Also, the Road Usage Rights may include an expiration upon which the rights expire. In this regard, the Road Usage Rights may be for a single carrying out of the Road Use, the Road Usage Rights may allow for multiple performances of the Road Use, and/or the Road Usage Rights may allow for unlimited performances of the Road Use before an expiration date/time.

In the above-embodiments in which the Road Usage Rights are time dependent, the system 200. Municipal Authority, and/or Road Use Credit Trading Platform 202 may transmit a start instruction to the Road User to instruct or permit starting of the Road Use. In addition to identifying a time, the start instruction may further identify a specific location or public space for carrying out the Road Use as described with respect to the first condition/parameter identified above. The start instruction may further be transmitted to the Road User or the user device a predetermined amount of time before a start of a specific time period during which the Road Use must or may be carried out.

Additionally or alternatively to the preceding paragraph, the system 200, Municipal Authority, and/or Road Use Credit Trading Platform 202 may transmit an end instruction to the Road User to end carrying out of the Road Use. The end instruction may further instruct the Road User to end usage of the specific location or public space at which the Road Use is carried out. The end instruction may be transmitted to the Road User a predetermined amount of time before an end of a specific time period during which the Road Use must or may be carried out.

When the end instruction instructs the Road User to stop carrying out the Road Use and/or to stop using the specific location or public space, a penalty transaction may be issued for the Road User when the Road Use is not stopped and/or usage of the specific location or public space is not ended. The penalty transaction may be for an amount of Road Use Credits which is equivalent to or corresponds to a predetermined amount or ration of the Exchange Rate of the Road Use. Of course, additional or alternative penalties may be applied without departing from the scope of the present application.

In addition to a penalty being applied to the Road User for not stopping the Road Use and/or usage of the specific location or public space upon expiration of the time limit and/or receipt of the end instruction, the system 200, Municipal Authority, and/or Road Use Credit Trading Platform 202 may transmit a control instruction to the Road User. The control instruction may control the Road User to stop the Road Use and/or exit the specific location or public space, such as when the Road User is an autonomous vehicle. In this regard, before assignment of the Road Usage Rights, the Road User may be required to provide access control information to the system 200, Municipal Authority, and/or Road Use Credit Trading Platform 202 for controlling the Road User. The access control information may comprise a password, authentication information, a digital fingerprint, and/or any additional information which allows the Road User to be controller.

The system 200, Municipal Authority, and/or Road Use Credit Trading Platform 202 may control the Road User to stop the Road Use and/or exit the specific location or public space via the control instruction and to, for example, move to a waiting or other area. The waiting or other area may be a private area in which fees or other requirements may be more strictly enforced. Accordingly, should the Road User not stop the Road Use and/or exit the specific location or public space in accordance with a time condition of the Road Usage Rights, the system 200, Municipal Authority, and/or Road Use Credit Trading Platform 202 may control the Road User to stop the Road Use and/or to move from the specific location or public space.

In any event, as a second condition or parameter, the Road Usage Rights may be time-limited as to when the Road Use must be undertaken. The period as to when the Road Use must be carried out may be time-limited in accordance with any of the situations described above, or in accordance with any additional or alternative situations which are generally known and understood in the art.

As an even further condition or parameter, the system 200, Municipal Authority, and/or Road Use Credit Trading Platform 202 may place quantity limits on the type or number of Road Uses which may take place at a same time and/or in a same location or area. In this regard, a warning instruction, the above-described penalty transaction, and the above-described control instruction may similarly apply to such further condition or parameter to enforce the quantity limits.

Accordingly, the Exchange Rate Calculation Algorithm 212 and/or the Road Use Credit Trading Platform 202 generally assign the Road Usage Rights to the Road Users for carrying out the Road Uses based on the Exchange Rates. In certain circumstances, however, the Exchange Rate Calculation Algorithm 212 and/or the Road Use Credit Trading Platform 202 may deny Road Use request or purchase. For example, a Road Use request or purchase may be denied for, but not limited to: the Road Use request or purchase conflicting with the space or safety requirements of existing Road Usage Rights purchased by other Road Users; the Road Use request or purchase would exceed limits defined by the Municipal Authority on certain Road Uses such as, for example, no more than three food stands being permitted within a certain area and traffic flow problems exist or are predicted to occur. Of course, these examples are merely exemplary and a Road Use request or purchase may be denied for additional or alternative reasons without departing from the scope of the present disclosure.

As shown in FIG. 2A, the system 200 further includes a Usage Management System 204, through which purchased Road Usage Rights may be implemented. In this regard, the Usage Management System 204 may coordinate the execution of public space utilization based on the distribution of Road Usage Rights, enabling a user-defined public space. For example, the Usage Management System 204 may comprise an application or other digital platform through which purchased Road Usage Rights are visible to the Road User and/or all other Road Users. The application or other digital platform may be integrated with, or be separate from, the User Interface 206.

The Usage Management System 204 may make all distributions of Road Usage Rights visible, or the Usage Management System 204 may involve only those distributions of Road Usage Rights which relate to a defined area, and/or which include limitations on the number and/or type of Road Use that can occur. For example, in a particular town square, the Municipal Authority may decide that only three temporary food stands may be present at one time. In such scenario, the location is already known. As a result, the application may simply indicate how many food stands currently own Road Usage Rights for the town square and whether any further rights are available for purchase. Of course, the above-described example is merely exemplary and not limiting.

The Usage Management System 204 may additionally or alternatively be implemented via an infrastructure system through which Road Usage Rights are communicated. This may include technologies such as screens, smart street signs, infrastructure to vehicle (I2V) communication, or other technologies which may dynamically indicate changing road layout due to Road Usage Rights. Of course, the Usage Management System 204 may be implemented in accordance with additional or alternative means which notify of assigned Road Usage Rights without departing from the scope of the present disclosure.

In further embodiments of the present disclosure, the system 200 may further include a Road Layout Planning Algorithm 218 as shown in FIG. 2B and FIG. 2C. The Road Layout Planning Algorithm 218 may determine an optimum road layout, e.g., the “Road Layout”, based on the existing Road Usage Rights. The Road Layout Planning Algorithm 218 may take into account, for example: Road Use type and any associated Road Use requirements; user preferences; traffic flow requirements; and pedestrian numbers. The Road Layout Planning Algorithm 218 may generate the optimum Road Layout, which would then be executed via the Usage Management System 204. The Road Layout Planning Algorithm 218 may dynamically adapt to changing requirements associated with, for example, new Road Usage Rights purchases; real-time requirement changes due to traffic flow problems, emergency situations, etc.; and predicted footfall changes due to weather, special events, etc. As a result, the Road Layout Planning Algorithm 218 provides the ability to generate an optimized space layout based on the needs of users in a public space, and to dynamically and autonomously alter the layout of such public space to regulate the activities and space use that may occur within it. In this regard, before the Usage Management System 204 implements newly purchased Road Usage Rights, the Road Layout Planning Algorithm 218 may determine an optimum Road Layout that maximizes the use of space under the new Road Use conditions. The Road Layout Planning Algorithm 218 may communicate the optimum Road Layout to the Usage Management System 204 for execution.

Accordingly, through the embodiments described herein, the users of public spaces are able to control the distribution of such spaces according to the specific needs of those users. By automating processes associated with the distribution of the spaces in a communal setting through the use of digital currency or credit, users can more readily influence the activities that may take place. By using technologies to dynamically adapt the permissions or layout within the spaces, communities are able to flexibly manage how their communal spaces are used in real-time, and local authorities gain the ability to effectively manage traffic and pedestrian requirements.

Through one or more of such embodiments, the following advantages, without limitation, may be realized. The maximize the use of public space by allowing users to trade away their unused credit to those who need it, ensuring that available space is utilized as much as is required. In addition, local users are able to directly and rapidly influence the use of public space, without the need for time-consuming interactions with local authorities. These local authorities are also able to unlock efficiencies by delegating space utilization on a local level to the people and organizations who wish to use it. Further, customized valuation of the various activities and uses enables their fair and reasonable purchase, in such a way as to reflect the impact those activities will have on the public space and its users. Also, utilization of public space gains increased flexibility, enabling a wider range of users to carry out a more diverse range of uses. In this regard, the features described herein may be applied in numerous scenarios whereby many users may have overlapping requirements for the space available to them. This may include, for example, public playing fields or parks (where various sports and leisure activities may come into conflict). Finally, but not lastly, enhanced management of traffic and pedestrian movements through applications and smart city infrastructure reduces congestion and overcrowding, ultimately improving living standards in the local area.

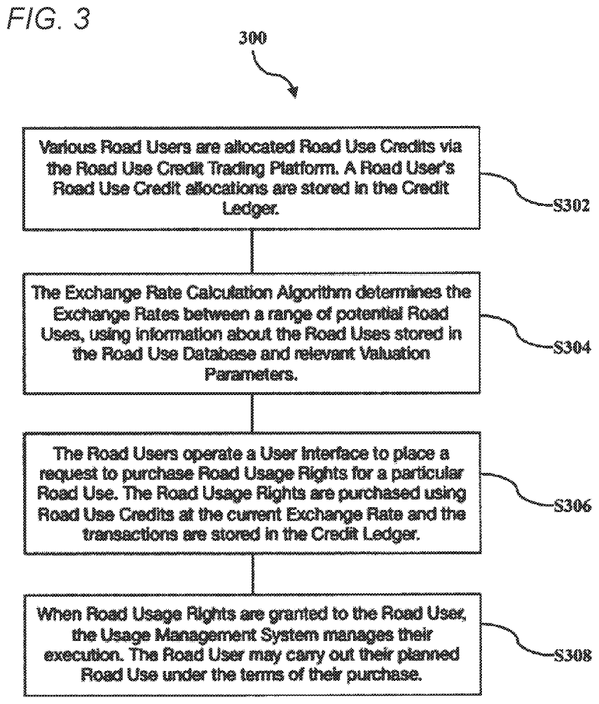

A non-limiting and exemplary method of a process for users to dynamically trade digital currency in exchange for the right to utilize an area or conduct an activity within a public space is shown at 300 in FIG. 3. In this regard, it is to be known and understood that the method 300 may be implemented in accordance with any combination of the features described herein. According to the method 300, Road Use Credits are distributed to Road Users by a Municipal Authority, or by other means such as per contractual agreement between users, at S302. The distribution of the Road Use Credits may be stored as transactions in a Credit Ledger, also at S302. An Exchange Rate Calculation Algorithm determines an appropriate Exchange Rate at which various Road Usage Rights may be purchased, using information about the Road Uses stored in a Road Use Database and depending on Valuation Parameters, at S304. The Valuation Parameters may change with, for example, current traffic, space availability, or Municipal Authority requirements at S304, resulting in variations in the Exchange Rates. The Road Users may wish to purchase Road Usage Rights to carry out various Road Uses. As a result, the Road Users access a Road Use Credit Trading Platform via a User Interface to purchase the Road Usage Rights at S306. The Road Users use Road Use Credits to purchase Road Usage Rights at the relevant Exchange Rate for their desired Road Use at S306, with the transactions being stored in the Credit Ledger. When Road Usage Rights are granted to the Road Users, a Usage Management System implements new Road Usage Rights, indicating new requirements to other Road Users at S308. The assignment of Road Usage Rights may be indicated by, for example, information in an application or via physical smart city infrastructure.

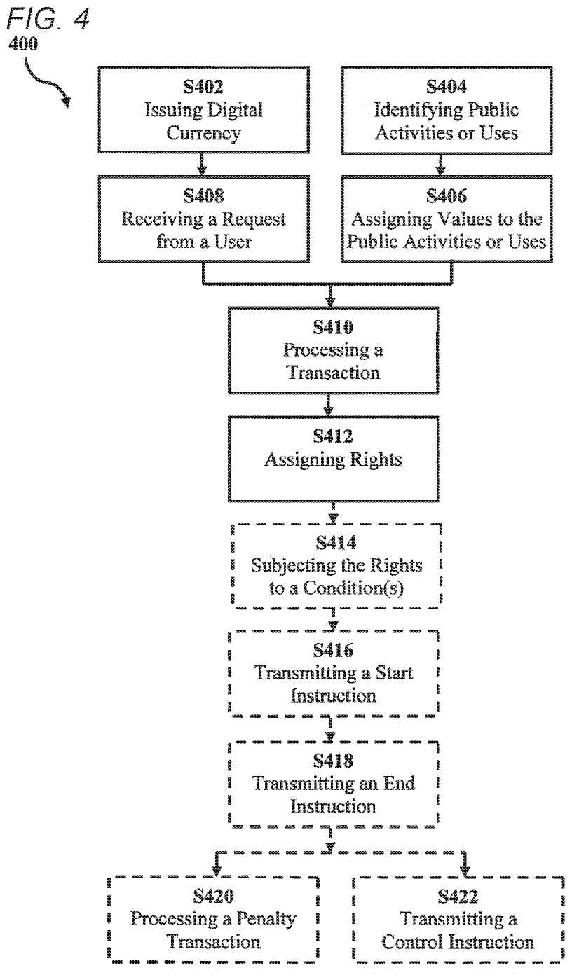

A further non-limiting and exemplary method for providing control and usage over public spaces is shown at 400 in FIG. 4. In this regard, it is again to be known and understood that the method 400 may be implemented in accordance with any combination of the features described herein. According to the method 400, digital currency is issued to each of a plurality of users (e.g., Road Users) at S402. Public activities or uses (e.g., Road Uses) that may be carried out by the plurality of users at the public spaces are identified at S404. Values (e.g., Exchange Values) are assigned to the public activities or uses at S406. A request from a user to carry out a public activity or use is received at S408. A transaction with the user is processed at S410, with the transaction authorizing the user to carry out the public activity or use and an amount of the digital currency (e.g., an Exchange Rate) of the user being acquired. Rights are assigned to the user (e.g., Road Usage Rights) to carry out the public activity or use in response to the transaction being completed at S412. The rights of the user to carry out the public activity or use may be subject to at least one condition at S414. A start instruction is transmitted to the user to permit usage of a specific location for carrying out the public activity or use at S416. An end instruction may be transmitted to the user to end usage of the specific location for carrying out the public activity at S418. A penalty transaction may be processed with the user in response to the user not ending usage of the specific location at S420. Lastly, a control instruction may be transmitted to a user device for controlling the user device to exit the specific location at S422.

While FIG. 3 and FIG. 4 show methods of the present disclosure, it is to be known and understood that these methods are not limiting or exhaustive. Additional or alternative methods may be implemented in accordance with any of the features described herein with respect to the remaining embodiments.

As an alternative method, the Exchange Rate for a Road Usage Right may vary depending on the demand from the Road Users who wish to purchase the Road Usage Right. That is, while FIG. 3 and FIG. 4 show that the Exchange Rate for a Road Usage Right is set, and then the Road User purchases the Road Usage Right by the set Exchange Rate, in the alternative method, the Exchange Rate Calculation Algorithm determines the demand for a particular Rod Usage Right, for example, based on the number of the Road Users who request purchase of the particular Road Usage Right. The Exchange Rate is dynamically determined in accordance with the demand. If the demand is high, the Exchange Rate increases, and if the demand is low, the Exchange Rate decreases. A maximum value or a minimum value may be set for the Exchange Rate.

Further, in accordance with the various embodiments described herein, the features described herein may be implemented using a hardware computer system that executes software programs, and the systems may be implemented using methods. Further, in an exemplary, non-limited embodiment, implementations can include distributed processing, component/object distributed processing, and parallel processing. Virtual computer system processing can be constructed to implement one or more of the methods or functionality as described herein, and a processor described herein may be used to support a virtual processing environment.

The various embodiments may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods. Further, any reference to claim elements in the singular, for example, using the articles “a,” “an” or “the”, is not to be construed as limiting the element to the singular.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed, rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

The present application claims the benefit of U.S. Provisional Patent Application No. 62/735,254 filed on Sep. 24, 2018. The entire disclosure of the above-identified application, including the specifications, drawings, and claim, is incorporated herein by reference in its entirety.

1. A system for providing control and usage over public spaces, the system comprising:
a processor; and
a memory including instructions that, when executed by the processor, cause the processor to perform operations including:
issuing digital currency to each of a plurality of users;
identifying public activities or uses that may be carried out by the plurality of users at the public spaces;
receiving a request from a user to carry out a public activity or use, the user being one of the plurality of users, the public activity or use being one of the public activities or uses;
assigning a value to the public activity or use, based at least on the public activity or use;
processing a transaction with the user, the transaction authorizing the user to carry out the public activity or use, an amount of the digital currency of the user being acquired in response to the transaction being completed, the amount of the digital currency corresponding to the value of the public activity or use; and
assigning rights to the user to carry out the public activity or use in response to the transaction being completed.

2. The system according to claim 1, wherein the operations further include:
subjecting the rights of the user to carry out the public activity or use, in response to the transaction being completed, to at least one condition.

3. The system according to claim 2, wherein the at least one condition, to which the rights of the user to carry out the public activity or use are subject, includes a specific location at which the public activity or use is to be carried out.

4. The system according to claim 4, wherein, in assigning rights to the user to carry out the public activity or use at the specific location, the processor limits assignments of rights for similar activities or uses that are to be carried out within a predetermined distance of the specific location to a predetermined number.

5. The system according to claim 3, wherein, in assigning the value to the public activity or use, the processor further assigns the value based on the specific location at which the public activity or use is to be carried out.

6. The system according to claim 5, wherein, in assigning the value to the public activity or use, the processor further assigns the value based on real-time use statistics of the public spaces.

7. The system according to claim 6, wherein the real-time use statistics of the public spaces includes real-time traffic conditions, the real-time traffic conditions being determined from vehicle sensors and autonomous vehicle reports.

8. The system according to claim 3, wherein
the request from the user to carry out the public activity or use includes a requested location, and
the specific location at which the public activity or use is to be carried out is determined by the processor to be within a predetermined distance of the requested location.

9. The system according to claim 3, wherein
the request from the user to carry out the public activity or use includes the specific location.

10. The system according to claim 9, wherein the operations further include:
identifying available locations of the public spaces at which the public activities or uses may be carried out by the plurality of users, the processor comparing current public space usage and current conditions with upcoming public space usage and predicted conditions.

11. The system according to claim 3, wherein the at least one condition, to which the rights of the user to carry out the public activity or use are subject, further includes a specific time period during which the public activity or use is to be carried out.

12. The system according to claim 11, wherein
the request from the user to carry out the public activity or use is at least one of received from a user device or identifies a user device, and
the operations further include:
transmitting a start instruction to the user device to permit usage of the specific location for carrying out the public activity or use by the user a predetermined amount of time before a start of the specific time period.

13. The system according to claim 12, wherein the operations further include:
transmitting an end instruction to the user device to end usage of the specific location for carrying out the public activity or use by the user a predetermined amount of time before an end of the specific time period.

14. The system according to claim 13, wherein the operations further include:
processing a penalty transaction with the user in response to the user not ending usage of the specific location by the end of the specific time period, a penalty amount of the digital currency of the user being acquired in response to the penalty transaction being completed, the penalty amount of the digital currency corresponding to a predetermined amount of the value of the public activity or use.

15. The system according to claim 12, wherein the operations further include:
transmitting a control instruction to the user device for controlling the user device to exit the specific location a predetermined amount of time before or after an end of the specific time period.

16. The system according to claim 3, wherein
the memory stores a layout of the public spaces, and
the operations further include:
dynamically altering the layout of the public spaces based on the rights assigned to the user to carry out the public activity or use; and
causing a physical infrastructure change to be instituted in response to the layout of the public spaces being dynamically altered.

17. The system according to claim 1, further comprising:
a platform for exchanging the digital currency of the plurality of users for rights to carry out the public activities or uses,
wherein the platform is further for trading the digital currency amongst the plurality of users, and for exchanging the rights to carry out the public activities or uses.

18. The system according to claim 1, wherein the operations further include:
issuing unique identifiers to each of the plurality of users, the digital currency being issued to each of a plurality of users in accordance with the unique identifiers; and
recording the transaction and the rights assigned to the user, to carry out the public activity or use in response to the transaction being completed, in a digital ledger in association with a unique identifier of the user.

19. A method for providing control and usage over public spaces, the method comprising:
issuing digital currency to each of a plurality of users;
identifying public activities or uses that may be carried out by the plurality of users at the public spaces;
receiving a request from a user to carry out a public activity or use, the user being one of the plurality of users, the public activity or use being one of the public activities or uses;
assigning, by a processor, a value to the public activity or use, based at least on the public activity or use;
processing, by the processor, a transaction with the user, the transaction authorizing the user to carry out the public activity or use, an amount of the digital currency of the user being acquired in response to the transaction being completed, the amount of the digital currency corresponding to the value of the public activity or use; and
assigning, by the processor, rights to the user to carry out the public activity or use in response to the transaction being completed.

20. A non-transitory computer-readable medium including a set of instructions for providing control and usage over public spaces that, when executed by a computer, causes the computer to perform operations comprising:
issuing digital currency to each of a plurality of users;
identifying public activities or uses that may be carried out by the plurality of users at the public spaces;
receiving a request from a user to carry out a public activity or use, the user being one of the plurality of users, the public activity or use being one of the public activities or uses;
assigning a value to the public activity or use, based at least on the public activity or use;
processing a transaction with the user, the transaction authorizing the user to carry out the public activity or use, an amount of the digital currency of the user being acquired in response to the transaction being completed, the amount of the digital currency corresponding to the value of the public activity or use; and
assigning rights to the user to carry out the public activity or use in response to the transaction being completed.
